(19) United States
(12) Patent Application Publication
(10) Pub. No.: US 2007/0151427 A1
(43) Pub. Date: Jul. 5, 2007

(54) Retractable handle for hand tools

(76) Inventors: Shih-Kun Chen, Taichung City (TW); Jen-Kai Li, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/319,662

(22) Filed: Dec. 29, 2005

(51) Int. Cl. B25B 23/16; B25G 1/04

(52) U.S. Cl. 81/177.2; 403/107

(57) ABSTRACT

A hand tool includes a retractable handle which includes a stationary section and a movable section movably mounted to the stationary section. The stationary section has an elongate slot and a plurality of dimples are defined in an inside of the elongate slot. The movable section has a connection end and a through hole. A bead is movably engaged with the through hole and can be engaged with one of the dimples. A collar is rotatably mounted to the connection end and a concavity is defined in an inner periphery of the collar. When the bead is received in the concavity and one of the dimples, the movable section is able to be moved relative to the stationary section to adjust the length of the handle. The movable section is secured when rotating the collar to press the bead by the inner periphery of the collar.

### FIELD OF THE INVENTION

The present invention relates to a retractable handle for a hand tool and the movable section of the handle can be easily moved relative to the stationary section.

### BACKGROUND OF THE INVENTION

A conventional hand tool generally includes a head and a handle wherein the handle has a fixed length so that when the object to be tightened or loosened is located in a deep position, the head cannot reach the object because to the handle with a fixed length. A conventional retractable handle is developed and includes a pin which extends through the movable section and the stationary section of the handle. A spring is located between the movable section and the stationary section so that when the pin is removed from the movable section and the. stationary section, the movable section is pushed by the spring and extended relative to the stationary section so that the handle is extended. However, the pin is exposed from the outside of the handle and might be hurt the user's hand. Furthermore, the movable section is pushed by the spring to its final position so that the user cannot select the length of the extended handle. In some circumstances, the length of the handle is also be limited.

The present invention intends to provide a retractable handle for a hand tool wherein the distance that the movable section moves relative to the stationary section can be controlled by the users.

### SUMMARY OF THE INVENTION

The present invention relates to a hand tool which comprises a head and a handle which includes a stationary section and a movable section movably mounted to the stationary section. The stationary section has an elongate slot with a plurality of dimples defined in an inside of the elongate slot. The movable section has a connection end and a through hole is defined through the connection end. A bead is movably engaged with the through hole and one of the dimples. A collar is rotatably mounted to the connection end and a concavity is defined in an inner periphery of the collar. The bead is received in the concavity when the collar is rotated to a position and the movable section can be moved relative to the stationary section at this position.

The primary object of the present invention is to provide a retractable handle for a hand tool wherein the movable section can be easily moved to adjust the length of the handle and the length of the handle can be controlled by the users.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the hand tool with the retractable handle of the present invention;

FIG. 2 is a perspective view to show the hand tool with the retractable handle of the present invention;

FIGS. 3 and 4 are two cross sectional views at different angles to show that the movable section is position at a first position relative to the stationary section;

FIG. 5 is an end cross sectional view to show that the bead is pressed by an inner periphery of the collar;

FIG. 6 is an end cross sectional view to show that the bead is received in the concavity in the inner periphery of the collar;

FIGS. 7 and 8 are two cross sectional views at different angles to show that the movable section is position at a second position relative to the stationary section;

FIG. 9 shows that a plate is connected to an inner periphery of the concavity and the bead pushes the plate to generate a “click” sound;

FIG. 10 is an end cross sectional view to show that the bead is pressed by an inner periphery of the collar;

FIG. 11 is an end cross sectional view to show that the bead is received in the concavity and contacts the plate in the inner periphery of the concavity, and FIG. 12 shows that the movable section is made by transparent material.

### DETAILED DESCRIPTION OF THE PREFERRED EMBODIMENT

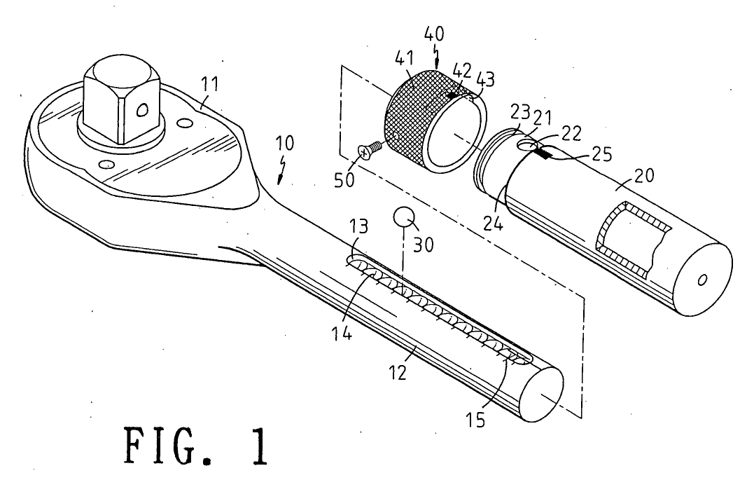

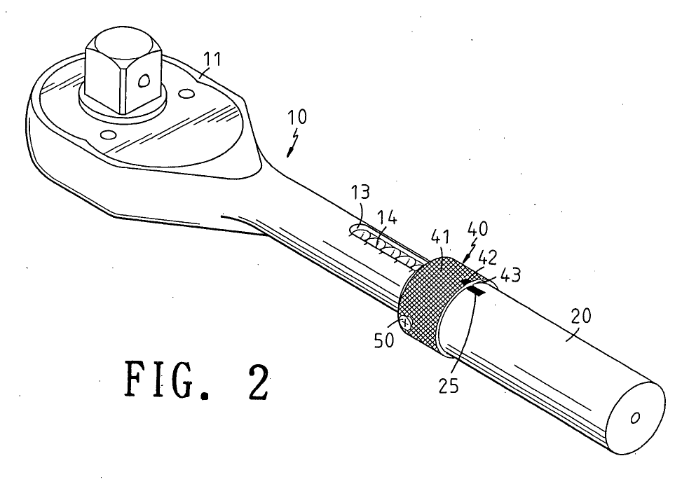

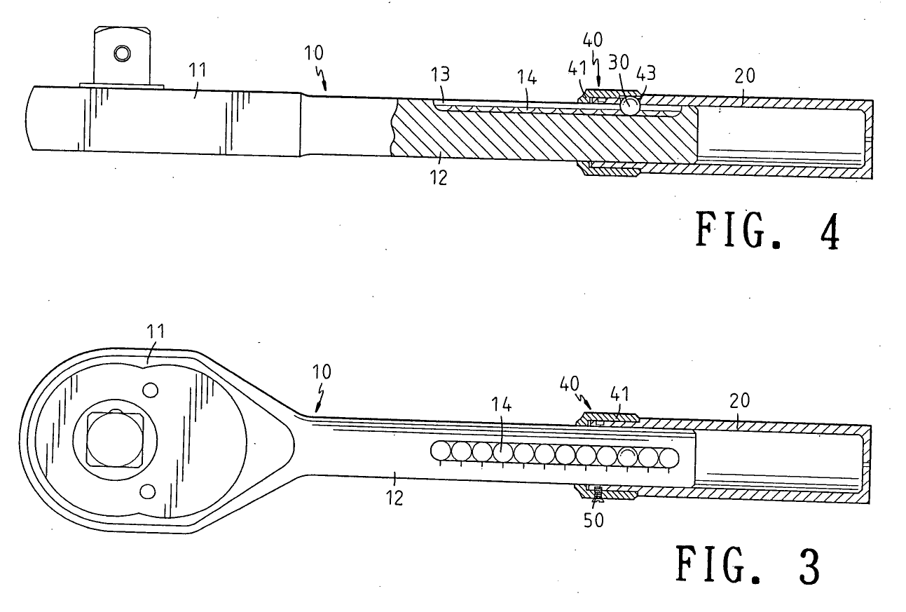

Referring to FIGS. 1 to 4, the hand tool of the present invention comprises a head 11 with a driving protrusion and a handle 10 which includes a stationary section 12 connected to the head 11 and a movable section 20 which is movably mounted to the stationary section 12. The stationary section 12 has an elongate slot 13 defined axially in an outer periphery thereof and a plurality of dimples 14 are defined in an inside of the elongate slot 13. A plurality of scale markings 15 are located along one side of the elongate slot 13.

The movable section 20 has a connection end 21 which has a diameter smaller than a diameter of the movable section 20, and a through hole 21 is defined through the connection end 21. The through hole 21 is in communication with one of the dimples 14. A bead 30 is movably engaged with the through hole 21 and one of the dimples 14. A groove 23 is defined in an outer periphery of the connection end 21.

A collar 40 is rotatably mounted to the connection end 21 and an end of the collar 40 contacts a shoulder 24 formed at the conjunction area of the connection end 21 with a smaller diameter and the movable section 20 with a larger diameter. The collar 40 includes a knurled outer surface 41 so that the user can easily rotate the collar 40. A concavity 43 is defined in an inner periphery of the collar 40. The bead can be received in the concavity 43 when the collar 40 is rotated to a position. A bolt 50 extends radially through the collar 40 and is engaged with a groove 23 defined in the connection end 21 so that the collar 40 can be only be rotated and cannot move in the axial direction.

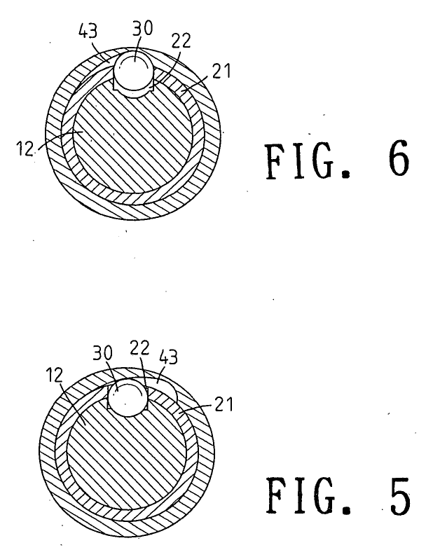

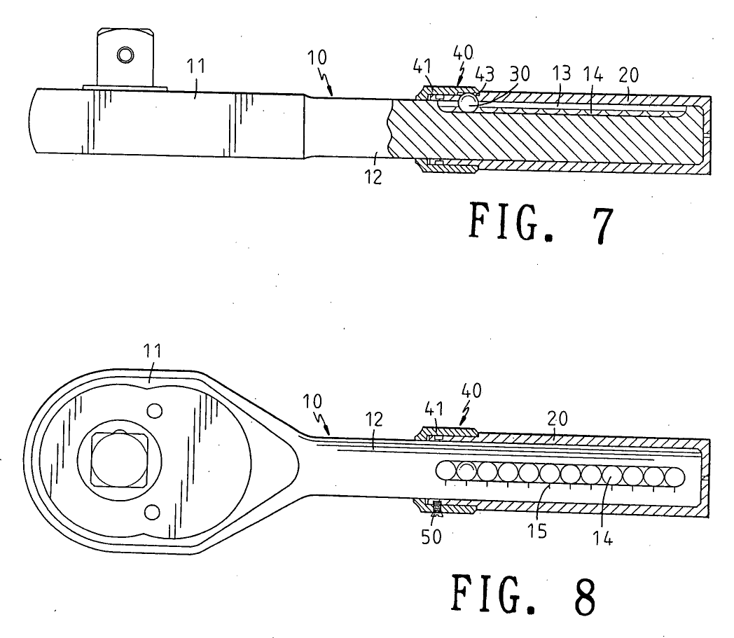

Referring to FIG. 5, when the bead 30 is pressed by the inner periphery of the collar 40, the connection end 21 together with the movable section 20 cannot be moved relative to the stationary section 12. When rotating the collar 40 to the position wherein a first mark 25 on the movable section 20 is in alignment with a second mark 42 on the collar 40, the bead 30 is engaged with the concavity 43 so that the movable section 20 is allowed to moved relative to the stationary section 12 to adjust the length of the handle by moving the bead 30 over the separations between the dimples 14 as shown in FIGS. 7 and 8. After the movable section 20 is moved to a desired position, the collar 40 is rotated an angle to shift the concavity 43 away from the bead 30 which is then pressed by the inner periphery of the collar 40 again. The scale markings 15 located along one side of the elongate slot 13 help the user to control the precise length of the handle.

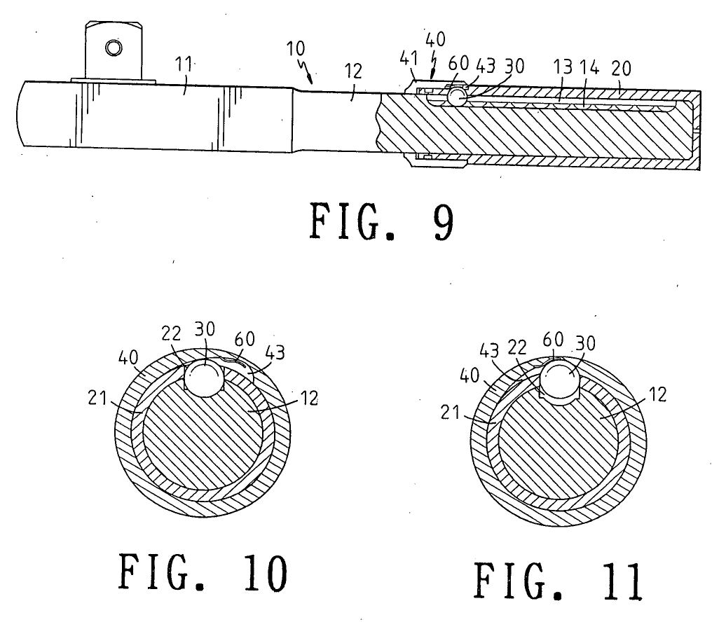

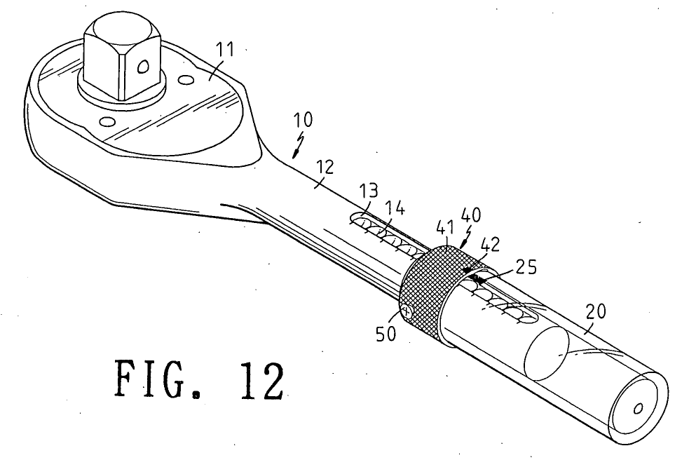

FIGS. 9 to 11 show that a plate 60 is connected to an inner periphery of the concavity 43 and when the bead 30 is engaged with the concavity 43 and pushes the plate 60, a “click” sound is heard to help the user to identify the correct position that the collar 40 is rotated.

FIG. 12 shows that the movable section 20 can be made by transparent material such as acrylic so that the user can see the movement of the movable section 20 relative to the stationary section 12.

While we have shown and described the embodiment in accordance with the present invention, it should be clear to those skilled in the art that further embodiments may be made without departing from the scope of the present invention.

What is claimed is:

1. A hand tool comprising:
a head and a handle which includes a stationary section and a movable section which is movably mounted to the stationary section, the stationary section having an elongate slot defined axially in an outer periphery thereof and a plurality of dimples defined in an inside of the elongate slot;
the movable section having a connection end and a through hole defined through the connection end, the through hole being in communication with one of the dimples, a bead movably engaged with the through hole and one of the dimples, and
a collar rotatably mounted to the connection end and a concavity defined in an inner periphery of the collar, the bead being received in the concavity when the collar is rotated to a position.

2. The hand tool as claimed in claim 1, wherein a plate is connected to an inner periphery of the concavity.

3. The hand tool as claimed in claim 1, wherein the connection end has a diameter smaller than a diameter of the movable section so as to form a shoulder against which an end of the collar contacts.

4. The hand tool as claimed in claim 1, wherein a bolt extends radially through the collar and is engaged with a groove defined in the connection end.

5. The hand tool as claimed in claim 1, wherein the movable section includes a first mark and the collar has a second mark which is rotated to be in alignment with the first mark when the collar is rotated to a position where the bead is engaged with the concavity.

6. The hand tool as claimed in claim 1, wherein the movable section is made by transparent material.

7. The hand tool as claimed in claim 1, wherein the stationary section includes scale markings located along one side of the elongate slot.

8. The hand tool as claimed in claim 1, wherein the collar includes a knurled outer surface.

9. The hand tool as claimed in claim 6, wherein the transparent movable section is made by acrylic.
